(19) United States
(12) Patent Application Publication
(10) Pub. No.: US 2024/0123830 A1
(43) Pub. Date: Apr. 18, 2024

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventor: Channy Park, Hwaseong-si (KR)

(73) Assignees: HYUNDAI MOTOR COMPANY, Seoul (KR); KIA CORPORATION, Seoul (KR)

(21) Appl. No.: 18/138,164

(22) Filed: Apr. 24, 2023

(30) Foreign Application Priority Data
Oct. 13, 2022 (KR) 10-2022-0131118

(51) Int. Cl. B60L 3/04; B60L 3/12; B60L 50/60

(52) U.S. Cl. CPC B60L 3/04; B60L 3/12; B60L 50/60

(57) ABSTRACT

A vehicle may include at least one battery and an input device configured to receive a user input for cutting off power supplied from the at least one battery. The vehicle may also include at least one first load configured to receive a first power from the at least one battery and at least one second load configured to receive a second power smaller than the first power from the at least one battery. The vehicle may further include a controller configured to cut off power supplied to the at least one first load or the at least one second load based on the user input received through the input device.

### CROSS-REFERENCE TO RELATED APPLICATION

This application claims the benefit of and priority to Korean Patent Application No. 10-2022-0131118, filed on Oct. 13, 2022, the entire contents of which are incorporated herein by reference.

### TECHNICAL FIELD

The present disclosure relates to a vehicle and a method of controlling the same.

### BACKGROUND

In general, a vehicle is a machine that travels on a road by driving wheels, and requires power for movement. Such vehicles may be classified into internal combustion engine vehicles and eco-friendly vehicles based on power sources.

Eco-friendly vehicles include electric vehicles and hybrid vehicles. An electric vehicle includes a battery, that is a chargeable power source, and a drive motor. The electric vehicle rotates the drive motor with electricity stored in the battery and drives wheels using rotation of the drive motor. A hybrid vehicle includes an engine, a battery, and a drive motor. The hybrid vehicle drives by controlling mechanical power of the engine and electrical power of the drive motor.

In addition, an eco-friendly vehicle typically includes a high-voltage battery that supplies power for starting and driving, and further includes a low-voltage battery that supplies power for driving various electric components to protect occupants and provide convenience and entertainment to the occupants.

However, in a situation where an eco-friendly vehicle is being check-up and maintained, if power is applied to a vehicle system due to power manipulation in a driver seat side, safety accidents such as electric shock may occur.

### SUMMARY

An aspect of the present disclosure provides a vehicle configured for preventing driving accidents and electric shock accidents by cutting off high-voltage power and low-voltage power supplied to the vehicle during vehicle maintenance, and a method of controlling the same.

Additional aspects of the present disclosure are set forth in part in the description which follows and, in part, should be apparent from the description, or may be learned by practice of the disclosure.

In an embodiment of the present disclosure, a vehicle includes at least one battery and an input device configured to receive a user input for cutting off power supplied from the at least one battery. The vehicle also includes at least one first load configured to receive a first power from the at least one battery and at least one second load configured to receive a second power smaller than the first power from the at least one battery. The vehicle further includes a controller configured to cut off power supplied to the at least one first load or the at least one second load based on the user input received through the input device.

In an aspect, the controller may be configured to, upon receiving the user input from the input device, cut off all power supplied to the at least one first load or the at least one second load.

In an aspect, the vehicle may further include a power controller configured to distribute the first power to the at least one first load. The controller may be configured to, upon receiving the user input from the input device, transmit an instruction to cut off supply of the first power to the power controller through a vehicle communication network.

In an aspect, the power controller may be configured to, upon receiving the instruction to cut off the supply of the first power, cut off the supply of the first power to the at least one first load.

In an aspect, the vehicle may further include a switch configured to cut off or supply the second power to the at least one second load. The controller may be configured to, upon receiving the user input from the input device, transmit an instruction to cut off supply of the second power to the switch through a vehicle communication network.

In an aspect, the switch may be configured to, upon receiving the instruction to cut off the supply of the second power, cut off the supply of the second power to the at least one second load.

In an aspect, the controller may be configured to, upon determining that the user input is received from the input device and the vehicle is in a stopped state, cut off all power supplied to the at least one first load or the at least one second load.

In an aspect, the controller may be configured to, upon determining that the vehicle is driving when the user input is received from the input device, continuously supply power to the at least one first load or the at least one second load.

In an aspect, the controller may be configured to determine whether the vehicle is in the stopped state based on at least one of a vehicle speed, a gear shifting, or a parking brake.

In another embodiment of the present disclosure, a method of controlling a vehicle including at least one battery, an input device receiving a user input for cutting off power supplied from the at least one battery, at least one first load receiving a first power, and at least one second load receiving a second power smaller than the first power is provided. The method includes determining whether the user input is received from the input device. The method also includes, upon receiving the user input from the input device, cutting off power supplied to the at least one first load or the at least one second load.

In an aspect, cutting off the power may include, upon receiving the user input from the input device, cutting off all power supplied to the at least one first load or the at least one second load.

In an aspect, the vehicle may further include a power controller configured to distribute the first power to the at least one first load. Cutting off the power may include, upon receiving the user input from the input device, transmitting an instruction to cut off supply of the first power to the power controller through a vehicle communication network.

In an aspect, the power controller may be configured to, upon receiving the instruction to cut off the supply of the first power, cut off the supply of the first power to the at least one first load.

In an aspect, the vehicle may further include a switch configured to cut off or supply the second power to the at least one second load. Cutting off the power may include, upon receiving the user input from the input device, transmitting an instruction to cut off supply of the second power to the switch through a vehicle communication network.

In an aspect, the switch may be configured to, upon receiving the instruction to cut off the supply of the second power, cut off the supply of the second power to the at least one second load.

In an aspect, the method may further include determining whether the vehicle is in a stopped state. Cutting off the power may include, upon determining that the user input is received from the input device and the vehicle is in the stopped state, cutting off all power supplied to the at least one first load or the at least one second load.

In an aspect, the method may further include determining whether the vehicle is in a stopped state, and, upon determining that the vehicle is driving when the user input is received from the input device, continuously supplying power to the at least one first load or the at least one second load.

In an aspect, determining whether the vehicle is in the stopped state may include determining whether the vehicle is in the stopped state based on at least one of a vehicle speed, a gear shifting, and a parking brake.

### BRIEF DESCRIPTION OF THE DRAWINGS

These and/or other aspects of the disclosure should become apparent and more readily appreciated from the following description of the embodiments, taken in conjunction with the accompanying drawings, in which:

FIG. 1 is an interior view illustrating a vehicle, according to an embodiment of the present disclosure;

FIGS. 2 and 3 are views illustrating power mode switching of a vehicle, according to an embodiment of the present disclosure;

FIG. 4 is a control block diagram illustrating a vehicle, according to an embodiment of the present disclosure;

FIG. 5 is a table illustrating whether a maintenance mode is switched in accordance with a driving state of a vehicle, according to an embodiment of the present disclosure;

FIG. 6 is a schematic view illustrating a configuration controlled by a power controller in a vehicle, according to an embodiment of the present disclosure;

FIG. 7 is a schematic view illustrating a configuration controlled by a switch in a vehicle, according to an embodiment of the present disclosure;

FIG. 8 is a flowchart illustrating a method for controlling a vehicle, according to an embodiment of the present disclosure; and

FIG. 9 is a flowchart illustrating an example of determining whether a vehicle is stopped in a method of controlling a vehicle, according to an embodiment of the present disclosure.

### DETAILED DESCRIPTION

Reference is now made in detail to embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

The terms “include” and “have” are intended to indicate the existence of elements disclosed in the specification, and are not intended to preclude the possibility that one or more other elements may exist or may be added. When a component, device, element, or the like of the present disclosure is described as having a purpose or performing an operation, function, or the like, the component, device, or element should be considered herein as being “configured to” meet that purpose or to perform that operation or function.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural unless it has a clearly different meaning in the context.

The reference numerals used in operations are used for descriptive convenience and are not intended to describe the order of operations. The operations may be performed in a different order unless otherwise stated.

Hereinafter, embodiments of the disclosure are described in detail with reference to the accompanying drawings.

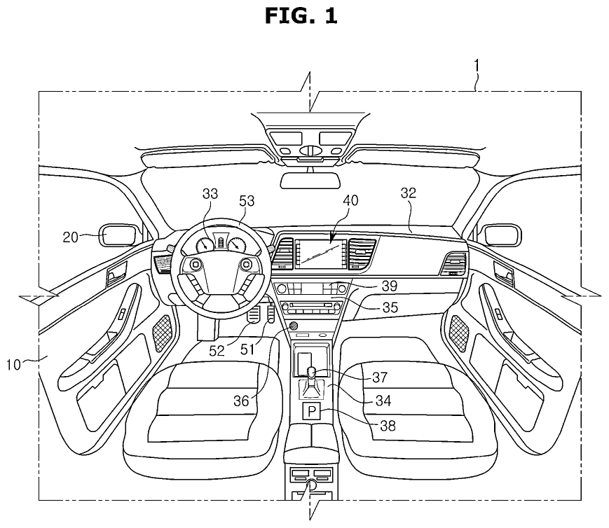

FIG. 1 is an interior view illustrating a vehicle, according to an embodiment of the present disclosure.

A vehicle 1 according to an embodiment may be an eco-friendly vehicle driven by electricity to reduce fuel consumption and harmful gas emissions.

The eco-friendly vehicle may include an electric vehicle, a hybrid vehicle, and hydrogen fuel cell vehicle. The electric vehicle may include a battery and a motor that are rechargeable power sources. The electric vehicle may rotate the motor with electricity accumulated in the battery and drive wheels using the rotation of the motor. The hybrid vehicle may include an engine, a battery, and a motor. The hybrid vehicle drive by controlling mechanical power of the engine and electrical power of the motor.

The vehicle 1 may include a body having an exterior and interior thereof, and a chassis supporting the body and having mechanical parts necessary for driving installed thereon except for the body.

The exterior of the vehicle body includes a front panel, a bonnet, a roof panel, a rear panel, doors 10 (front, rear, left, and right), and window glass provided to be able to open and close on the doors 10.

The exterior of the vehicle body may include a side mirror 20 that provides a driver with a backward field of view of the vehicle 1. The exterior of the vehicle body may also include a lamp that allows the driver to easily see surrounding information while keeping an eye on a forward field of view and performs a function of signaling and communicating with other vehicles and pedestrians.

As shown in FIG. 1, the interior of the vehicle body includes a dashboard 32 and a cluster 33 disposed on the dashboard 32. The cluster 33 may include a tachometer, a speedometer, a coolant temperature gauge, a fuel gauge, a turn indicator, a high beam indicator, a warning lamp, a seat belt warning light, an odometer, a shift lever indicator, a door open warning light, an engine oil warning light, and a low fuel warning light. The interior of the vehicle also includes a center fascia 34 on which the vents and control plate of an air conditioner 410 are disposed, a head unit 35 provided on the center fascia 34 and receiving operation instructions of an audio device and the air conditioner, and a start button 36 provided on the center fascia 34 and receiving start instructions.

The vehicle 1 may further include a shift lever 37 provided on the center fascia 34 and receiving an input position for operation, and a parking button 38 (electronic parking brake (EPB) button) for receiving operation instructions of EPB device (not shown) positioned around the shift lever 37 or on the head unit 35.

The vehicle 1 further includes an audio/video/navigation (AVN) device 40 (also referred to herein as a “terminal for vehicle”) for user convenience. The AVN device 40 may be disposed on the dashboard 32 as an embedded type or a mounted type.

The vehicle 1 may also include an accelerator pedal 51 that is depressed by a user according to the user's intention to accelerate, a brake pedal 52 that is depressed by the user according to the user's intention to brake, and a steering wheel 53 of a steering device for adjusting a driving direction of the vehicle.

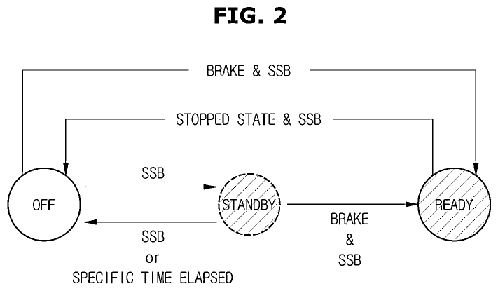

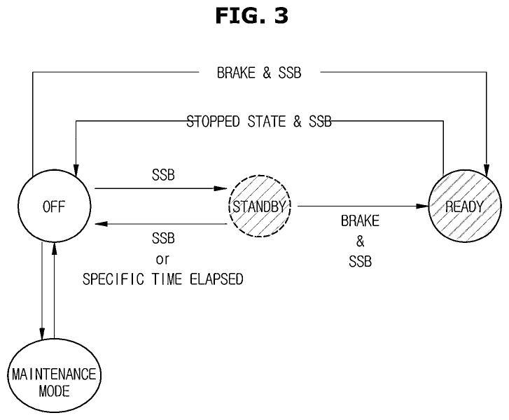

FIG. 2 and FIG. 3 are views illustrating power mode switching of a vehicle, according to an embodiment of the present disclosure.

Referring to FIG. 2, a power mode of the vehicle may include an off mode, a standby mode, and a ready mode.

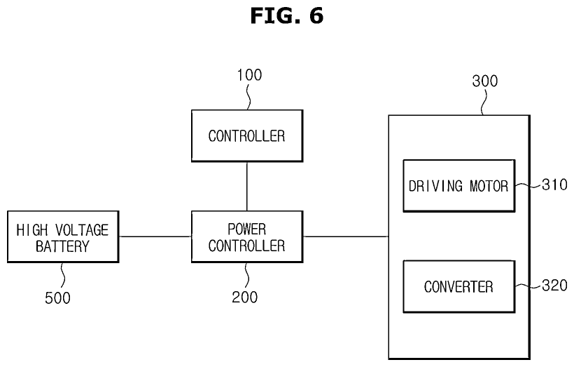

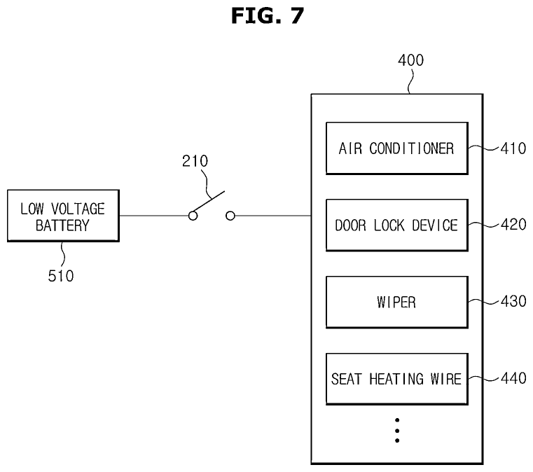

Referring also to FIGS. 6 and 7, the off mode is a mode in which power supply of a high voltage battery 500 is cut off and dark current is applied to predetermined electronic components through a low voltage battery 510.

The standby mode is a mode in which power supply to a driving motor 310 is cut off and power is supplied to predetermined electronic components.

The ready mode is a mode for supplying power to the driving motor 310 and electronic components.

Each mode may be switched with each other. For example, referring to FIG. 2, by pressing the start button (also referred to herein as a “start/stop button (SSB)”) 36 in the off mode, the off mode may be switched to the standby mode and after switched thereto, the standby mode may be switched to the off mode when a specific time elapses. In addition, by pressing the start button while depressing the brake pedal in the standby mode, the standby mode may be switched to the ready mode. Accordingly, a driver may efficiently use the electric power of the vehicle.

Referring to FIG. 3, the power mode of the vehicle may further include a maintenance mode.

Referring also to FIGS. 6 and 7, the maintenance mode is a mode in which both the power of the high voltage battery 500 and the power of the low voltage battery 510 are cut off. Furthermore, when switched to the maintenance mode, it is not available to switch from the driver seat side to a mode in which power is supplied to vehicle electronic components, such as the standby mode or the ready mode.

The maintenance mode has advantages of preventing safety accidents such as electric shock or the like during vehicle maintenance. For example, if there is a distance between an engine room and a driver seat, such as in a bus, or if a driver starts the vehicle without recognizing that the vehicle is being maintained, an accident may be prevented.

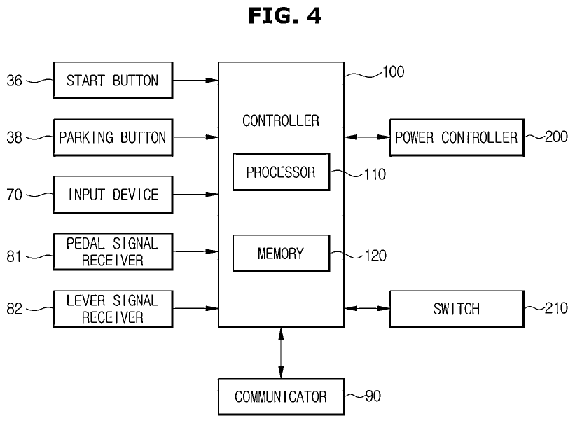

A method of operating the maintenance mode of the vehicle, according to an embodiment, is described below with reference to FIGS. 4 to 7.

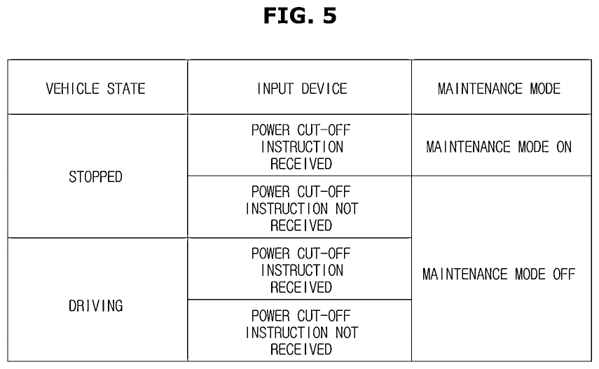

FIG. 4 is a control block diagram illustrating a vehicle according to an embodiment. FIG. 5 is a table illustrating whether the maintenance mode is switched according to a driving state of a vehicle according to an embodiment. FIG. 6 is a schematic view illustrating a configuration controlled by a power controller 200 in a vehicle according to an embodiment. FIG. 7 is a schematic view illustrating a configuration controlled by a switch 210 in a vehicle according to an embodiment.

Referring to FIG. 4, the vehicle may include the start button 36, the parking button 38, an input device, a pedal signal receiver 81, a lever signal receiver 82, a communicator 90, a controller 100, a power controller 200, and the switch 210.

The start button 36 may be manipulated by the user. The start button 36 may receive a start-on instruction and a start-off instruction as a user input, and may transmit a start-on signal corresponding to the received start-on instruction and a start-off signal corresponding to the start-off instruction, to the controller 100.

The parking button 38 may be manipulated by the user. The parking button 38 may receive a parking-on instruction and a parking-off instruction as a user input, and may transmit a parking-on signal corresponding to the received parking-on instruction and a parking-off signal corresponding to the parking-off instruction, to the controller 100. The parking-off signal of the parking button may be a release signal of a parking brake device.

The input device is located in a Powertrain Electrics (PE) room of the vehicle 1 and is configured to receive the user input for cutting off power supplied from the battery. When receiving a power cut-off input from the user, the input device 70 may transmit the power cut-off input to the controller 100.

The input device may be provided in the form of the switch 210 or a button so that the user may input an instruction by pressing, turning up, or turning down the input device 70. However, the disclosure is not limited to the above-described examples, and as long as it is a device configured for receiving a user's input, the method or form is not limited thereto.

The pedal signal receiver 81 may receive a pedal signal corresponding to pressing of the brake pedal 52 and transmit the received pedal signal to the controller 100.

The pedal signal receiver 81 may be connected to a pedal force detector (not shown) and may be configured to receive a signal from the pedal force detector.

The pedal force detector may be one of a force sensor configured for detecting a force corresponding to the pressing of the brake pedal 52, a load cell configured for detecting a load corresponding to the pressing of the brake pedal 52, an angle sensor configured for detecting a rotational angle of the brake pedal 52 relative to a rotation axis corresponding to the pressing of the brake pedal 52, a displacement sensor configured for detecting a change in the position of the brake pedal 52 corresponding to the pressing of the brake pedal 52, and a pedal stroke sensor configured for detecting a stroke corresponding to the pressing of the brake pedal 52.

The lever signal receiver 82 may be connected to the shift lever 37 and may be configured to receive a lever signal corresponding to an operating position of the shift lever 37. For example, the lever signal receiver 82 may receive a signal of ‘drive’ (D) gear position, a signal of ‘reverse’ (R) gear position, a signal of ‘neutral’ (N) gear position, and a signal of ‘park’ (P) gear position.

The vehicle may further include a speed detector (not shown) configured for detecting a driving speed. The speed detector may include at least one of a plurality of wheel speed sensors and/or acceleration sensors.

The communicator 90 may include one or more components enabling communication between an external device (not shown) and internal components of the vehicle, or therebetween. For example, the communicator 90 may include at least one of a short-range communication module, a wired communication module, and/or a wireless communication module.

The external device may include a vehicle manufacturer, a vehicle maintenance center, or a server providing a vehicle maintenance app. The external device may further include a remote controller and/or a terminal for a user.

The short-range communication module may include various short-distance communication modules for transmitting and receiving signals using a wireless communication network in a short distance, such as a Bluetooth module, an infrared communication module, a radio frequency identification (RFID) communication module, a wireless local access network (WLAN) communication module, a near field communication (NFC) module, a Zigbee communication module, or the like.

The wired communication module may include various wired communication modules, such as a local area network (LAN) module, a wide area network (WAN) module, or a value added network (VAN) module. The wired communication module may also include various cable communication modules, such as a universal serial bus (USB) module, high definition multimedia interface (HDMI), digital visual interface (DVI), recommended standard232 (RS-232), a power line communication, and plain old telephone service (POTS), or the like.

The wireless communication module, in addition to a Wifi module and a wireless broadband (Wibro) module, may include a wireless communication module supporting various wireless communication methods such as, global system for mobile communication (GSM), code division multiple access (CDMA), wideband code division multiple access (WCDMA), universal mobile telecommunications system (UMTS), time division multiple access (TDMA), long term evolution (LTE), and ultra wide band (UWB) modules, or the like.

The controller 100 may include at least one processor 110 and a memory 120. For example, the controller 100 may include an electronic control unit (ECU), a micro controller unit (MCU), or other lower level controllers, which are mounted in the vehicle 1.

The processor 110 may comprise a central processing unit (CPU) or at least one dedicated processor 110 on which operations and/or methods performed by a device according to an embodiment of the present disclosure are performed.

The processor 110 may process signals received from the start button 36, the parking button 38, the input device 70, the pedal signal receiver 81 and the lever signal receiver 82 to set the power mode of the vehicle.

For example, when the driver presses only the start button 36, the processor determines that it is the standby mode, thereby cutting off the power supply of the driving motor 310 and allowing the power supply only to predetermined electronic components. When the driver presses the start button 36 while depressing the brake pedal, the processor determines as the ready mode, thereby allowing the power supply to the drive motor 310 and the electronic components.

Furthermore, upon receiving a power cut-off instruction input from the user through the input device 70, the processor 110 switches the power mode of the vehicle to the maintenance mode, thereby cutting off all the power of the high voltage battery 500 and the power of the low voltage battery 510, and cutting off switching from the driver seat side to a mode in which power is supplied to electronic components of the vehicle, such as the standby mode or the ready mode.

Referring to FIG. 5, the processor 110 may switch the power mode of the vehicle to the maintenance mode when the vehicle is in a stopped state and the power cut-off instruction input from the user through the input device 70 is received. When the vehicle is driving, switching to the maintenance mode may not performed when the power cut-off instruction is received.

The processor 110 may determine that the vehicle is in the stopped state when the speed of the vehicle is 0 km/h based on speed information detected by the speed detector (not shown).

Upon receiving the signal from the parking button 38, the processor 110 may determine that the vehicle is in the stopped state.

Upon determining that the signal received by the lever signal receiver 82 is a signal of park or neutral gear positions, the processor 110 may determine that the vehicle is in the stopped state.

When switching to the maintenance mode, the processor 110 may transmit the power cut-off instruction to the power controller 200 and the switch 210 via a communication network for a vehicle (CAN).

When switching to the maintenance mode, the processor 110 may inform the registered user terminal (e.g., a mobile device) that the vehicle is currently being serviced.

The processor 110 may execute program instructions stored in the memory 120. The memory 120 may be composed of volatile storage media and/or non-volatile storage media. For example, the memory 120 may include a read only memory (ROM) and/or a random access memory (RAM).

Memory 120 may store at least one instruction (or command). More specifically, the memory 120 may store at least one instruction executable by the processor 110. For example, the controller 100 may include an instruction to transmit an instruction to cut off the power supply of a first power to the power controller 200 and an instruction to transmit an instruction to cut off the power supply of a second power to the switch 210.

However, the disclosure is not limited thereto. For example, the memory 120 may include instructions related to operations described below, and the processor 110 may execute programs related to the above operations and operations described below. Furthermore, the memory 120 may store at least one piece of data calculated by the execution of the processor 110.

Referring to FIG. 6, the power controller 200 may distribute power supplied from the high voltage battery 500 to a first load 300. The first load 300 may comprise a load to which the first power is supplied, and may include, for example, the driving motor 310 and a converter 320.

Upon receiving the instruction to cut off the power supply of the first power from the processor 110, the power controller 200 may cut off the power supply of the first power to the first load 300. For example, the power controller 200 may quickly discharge the remaining high voltage in the driving motor 310 by instructing the driving motor 310 to stop using, and instruct the converter 320 to stop converting the high voltage into the low voltage. Furthermore, the power controller 200 may give a command a voltage supply stop instruction to the high voltage battery 500.

Referring to FIG. 7, the switch 210 may cut off or provide the power supplied from the low voltage battery 510 to a second load 400. The switch 210 may be turned on or off in response to a control instruction of the processor 110. The switch 210 may be a relay.

The second load 400 may comprise to a load to which the second power is supplied, and includes, for example, an air conditioner 410 that heats or cools indoor air according to the room temperature, a door lock device 420, and a wiper 430, power seats, seat heating wires 440, seat ventilators, interior lamps, or the like. The second power refers to a power source having a smaller voltage than the first power.

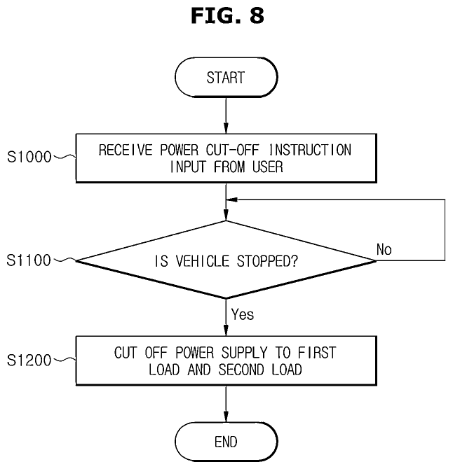

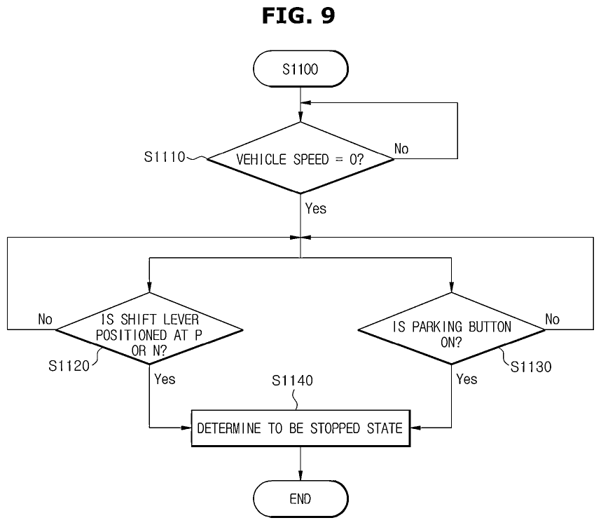

FIG. 8 is a flowchart illustrating a method for controlling a vehicle, according to an embodiment of the present disclosure FIG. 9 is a flowchart illustrating an example of determining whether the vehicle is stopped in the method for controlling the vehicle, according to an embodiment of the present disclosure. It should be understood that these are merely example embodiments for achieving the object of the present disclosure, and some operations may be added or deleted as needed.

In operation S1000, the input device 70 receives the power cut-off instruction input from the user. Upon receiving the power cut-off instruction input from the user, the input device 70 may transmit the instruction to the controller 100.

In operation S1100, the controller 100 may determine, upon receiving the power cut-off instruction input from the user through the input device 70, whether the vehicle is in the stopped state.

Referring to FIG. 9, in operation S1110, the controller 100 determines whether the speed of the vehicle is 0 km/h. The controller 100 identifies the speed of the vehicle based on speed information detected by the speed detector (not shown).

Upon determining that the speed of the vehicle is 0 km/h, in operation S1120, the controller 100 determines whether the shift lever is positioned at the park gear position or the neutral gear position based on the lever signal from the lever signal receiver 82.

Upon determining that the speed of the vehicle is 0 km/h, in operation S1130, the controller 100 determines whether the signal from the parking button 38 has been received.

Upon determining that the speed of the vehicle is 0 km/h and the shift lever is positioned at the park gear or the neutral gear, or the speed of the vehicle is 0 km/h and the signal from the parking button 38 has been received, in operation S1140, it is determined that the vehicle is in the stopped state.

Referring back to FIG. 8, upon determining that the power cut-off instruction is received from the user and the vehicle is in the stopped state, in operation S1200, the power supply to the first load 300 and the second load 400 is cut off.

The power controller 200 may cut off the power supply of the first power to the first load 300 upon receiving the instruction to cut off the power supply of the first power from the processor 110. For example, the power controller 200 may quickly discharge the remaining high voltage in the driving motor 310 by instructing the driving motor 310 to stop using, and instruct the converter 320 to stop converting the high voltage into the low voltage. Furthermore, the power controller 200 may give a command a voltage supply stop instruction to the high voltage battery 500.

The switch 210 may be turned off in response to the control instruction of the processor 110 to cut off the power supplied to the second load 400.

As is apparent from the above, various embodiments of the present disclosure may provide a vehicle configured for preventing driving accidents and electric shock accidents by cutting off high-voltage power and low-voltage power supplied to the vehicle during vehicle maintenance, and a method of controlling the same.

In embodiments, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the present disclosure have been shown and described, it should be appreciated by those having ordinary skill in the art that changes may be made in these embodiments without departing from the principles and spirit of the disclosure.

What is claimed is:

1. A vehicle, comprising:
at least one battery;
an input device configured to receive a user input for cutting off power supplied from the at least one battery;
at least one first load configured to receive a first power from the at least one battery;
at least one second load configured to receive a second power smaller than the first power from the at least one battery; and
a controller configured to cut off power supplied to the at least one first load or the at least one second load based on the user input received through the input device.

2. The vehicle of claim 1, wherein the controller is further configured to, upon receiving the user input from the input device, cut off all power supplied to the at least one first load or the at least one second load.

3. The vehicle of claim 1, further comprising a power controller configured to distribute the first power to the at least one first load,
wherein the controller is further configured to, upon receiving the user input from the input device, transmit an instruction to cut off supply of the first power to the power controller through a vehicle communication network.

4. The vehicle of claim 3, wherein the power controller is configured to, upon receiving the instruction to cut off the supply of the first power, cut off the supply of the first power to the at least one first load.

5. The vehicle of claim 1, further comprising a switch configured to cut off or supply the second power to the at least one second load,
wherein the controller is configured to, upon receiving the user input from the input device, transmit an instruction to cut off supply of the second power to the switch through a vehicle communication network.

6. The vehicle of claim 5, wherein the switch is configured to, upon receiving the instruction to cut off the supply of the second power, cut off the supply of the second power to the at least one second load.

7. The vehicle of claim 1, wherein the controller is configured to, upon determining that the user input is received from the input device and the vehicle is in a stopped state, cut off all power supplied to the at least one first load or the at least one second load.

8. The vehicle of claim 1, wherein the controller is configured to, upon determining that the vehicle is driving when the user input is received from the input device, continuously supply power to the at least one first load or the at least one second load.

9. The vehicle of claim 7, wherein the controller is further configured to determine whether the vehicle is in the stopped state based on at least one of a vehicle speed, a gear shifting, or a parking brake.

10. A method of controlling a vehicle including at least one battery, an input device receiving a user input for cutting off power supplied from the at least one battery, at least one first load receiving a first power, and at least one second load receiving a second power smaller than the first power, the method comprising:
determining whether the user input is received from the input device; and
upon receiving the user input from the input device, cutting off power supplied to the at least one first load or the at least one second load.

11. The method of claim 10, wherein cutting off the power includes, upon receiving the user input from the input device, cutting off all power supplied to the at least one first load or the at least one second load.

12. The method of claim 10, wherein:
the vehicle further includes a power controller configured to distribute the first power to the at least one first load, and
cutting off the power includes, upon receiving the user input from the input device, transmitting an instruction to cut off supply of the first power to the power controller through a vehicle communication network.

13. The method of claim 12, further comprising: upon receiving the instruction to cut off the supply of the first power, cutting off, by the power controller, the supply of the first power to the at least one first load.

14. The method of claim 10, wherein:
the vehicle further includes a switch configured to cut off or supply the second power to the at least one second load, and
cutting off the power includes, upon receiving the user input from the input device, transmitting an instruction to cut off supply of the second power to the switch through a vehicle communication network.

15. The method of claim 14, further comprising: upon receiving the instruction to cut off the supply of the second power, cutting off, by the switch, the supply of the second power to the at least one second load.

16. The method of claim 10, wherein cutting off the power includes:
determining whether the vehicle is in a stopped state, and
upon determining that the user input is received from the input device and the vehicle is in the stopped state, cutting off all power supplied to the at least one first load or the at least one second load.

17. The method of claim 10, further comprising:
determining whether the vehicle is in a stopped state, and
upon determining that the vehicle is driving when the user input is received from the input device, continuously supplying power to the at least one first load or the at least one second load.

18. The method of claim 17, wherein determining whether the vehicle is in the stopped state comprises determining whether the vehicle is in the stopped state based on at least one of a vehicle speed, a gear shifting, or a parking brake.
